(19) United States
(12) Patent Application Publication
(10) Pub. No.: US 2003/0074425 A1
(43) Pub. Date: Apr. 17, 2003

(54) Browser with proxy server and information copying system

(75) Inventor: Jun Kawakita, Tokyo (JP)

Correspondence Address: FAY, SHARPE, BEALL,, FAGAN, MINNICH & McKEE, Suite 700, 1100 Superior Avenue, Cleveland, OH, 44114, US

(73) Assignee: MVP Kabushiki Kaisha

(21) Appl. No.: 10/269,304

(22) Filed: Oct. 11, 2002

(30) Foreign Application Priority Data
Oct. 12, 2001 (JP) 2001-315484

(51) Int. Cl. G06F 15/16

(52) U.S. Cl. 709/219

(57) ABSTRACT

A system, which can support the agent skill in real time when the agent, who does outside seals activity, has the meeting with the client. A browser 4(14) with proxy server includes a proxy module 2(12) and a browser module 1 (11) capable of receiving a content cache update event from the proxy module 2(12). The browser 4(14) with proxy server is set up in an operator computer 8 operated by a sales activity supporter, who is a specialist and in an agent computer 18 operated by a salesperson in a state remote from the operator computer in a high-speed and stable operating state, and synchronization is made between virtual browsers 4 and 14. The computers 8 and 18 provided with these browsers are exchangeable and connectable by a network 7, and the operator computer 8 is connected with a Web server 5 for acquiring update information so that an information copying system can be constituted. By doing so, browsing object information such as Web page acquired in the operator computer 8 is automatically copied, and thereafter, is displayed on the agent computer 18.

### BACKGROUND OF THE INVENTION

1. Field of the Invention

The present invention relates to a browser with a proxy server, an information copying system and a using method thereof. In particular, the present invention relates to a browser with a proxy server, an information copying system and a using method thereof, which can copy a browsing object information such as Web page and video image displayed by a browser from a sales activity supporter computer to a salesperson computer in a high-speed and stable operating state between a remote-controlled sales activity supporter computer and a salesperson computer, which are connected via a Web system such as Internet (hereinafter, referred to as “Web”).

2. Description of the Related Art

Conventionally, in outside sales activity of company and the like, an amount of portable materials is limited; for this reason, there is a limitation in quantity and quality of information capable of providing to customers (hereinafter, referred to as “client”). Therefore, when a salesperson meets a client at the first time and must provide effective business information relative to the client, the salesperson (hereinafter, referred to as “agent”) does not have materials relative to the client information, and is lack of knowledge relative to the client; for this reason, sufficient information is not provided to the client. As a result, a business change is lost, and suitable measures relative to the client are late in taking, and thereby, there is a problem such that effective business activities are limited. On the other hand, in order to solve the above problem, if a specialist having technical knowledge takes charge of the agent, many specialists must be secured; for this reason, there is a problem in business management.

Further, in the outside sales activity of company, there exists the difference in knowledge and skill depending on the agent; for this reason, individual difference is frequently generated in sales record. It is a very important problem for the employer side to effectively educate the agent lacking in knowledge and skill. However, it is almost impossible to support the agent, who always moves and does sales activity, in his skill in real time. In addition, the agent lacking in skill does the sales activity, and thereby, there are various problems such that erroneous information is provided to the client.

In order to solve the above various problems, conventionally, there has been proposed the following method. According to the method, the agent has a portable agent computer connectable to Web system, and information for sales activity is copied from a company computer to a mobile computer using remote control software. To give an example, there exists “pcAnywhere” and “WinShare” as the above remote control software.

FIG. 5 is a view to explain an operation concept of the “pcAnywhere”. In FIG. 5, Windows application is operated on an operated personal computer (hereinafter, referred to as “PC”), and a processing request to “Windows API” is transmitted from the application to an operating PC side by a hookup routine of the pcAnywhere. Then, in the operating PC side, the processing request to the Windows API is carried out as if the processing request thus transmitted is a request from the application by an emulator routine. Further, the operation on the operating PC is transmitted to Windows application on the operated PC passing through the path converse to above.

The pcAnywhere is used for the main purpose of operating a PC or PC server positioned at remote place by its subordinate PC, and needs to operate various PCs by remote control. For this reason, the pcAnywhere acquires a software operating state at operating system level and hardware level, and then, transmits and receives information between the remote place PC and the self computer. However, the number of hooks of the Windows API is several ten thousands; for this reason, there is a limit in information transmission with the remote place PC via all of these hooks. For example, in screen drawing, bit map information must be transferred, and information content of a standard screen size (1024 (768 pixel, 256 colors) is 786 kilobytes (hereinafter, referred to as “KB”. Even if the information content is compressed into about ⅕ size, 20 seconds is taken to transfer the information content via an ISDN line.

Further, the pcAnywhere does not support all applications, and for example, software dealing voice and video image depends directly on hardware; in this case, remote control is impossible.

As described above, the remote control software has the following problem; more specifically, there is a limit in dealing large size information on the operation principle, speed is late, and the operating state is unstable. For this reason, the remote control software is a method unsuitable for supporting the skill in outside sales activity having a meeting with the client in real time. As a result, it has been desired to find the method for solving the above problem.

### SUMMARY OF THE INVENTION

Accordingly, an object of the present invention is to solve the above problems in the prior art, and to support the agent's skill in real time when the agent has a meeting with the client in outside sales activity. Namely, an object of the present invention is to provide a method, which can copy a browsing object information such as Web page and video image displayed by browser, from a computer operated by a sales activity supporter (hereinafter, referred to as “operator”) to a computer operated by an agent in a state remote from the operator computer in a high-speed and stable operating state.

The present inventors have earnestly studied the above problem; as a result, they have found the following matter. More specifically, a browser with proxy server comprising a browser module and a proxy module is set up with respect to the following both computers. One is a computer (operator computer) operated by an operator, who is a specialist capable of supporting agent's sales activity and having technical knowledge, and another is a computer (agent computer) operated by the agent in a state remote from the operator computer. Further, synchronization is made between both browsers with proxy server, and thereby, high efficiency of communication can be readily achieved. In this manner, the present invention has been made as means for solving the above problem.

(1) In order to achieve the above object, the present invention provides a browser with a proxy server comprising:

a browser module having a browsing function for decoding a hypertext and the like, and displaying a designated Web content; and

a proxy module having a function for accepting an access request by http protocol from a terminal, acting a connection request from the terminal as a proxy, storing access designated page information as a cache, and relaying communication between the access designated destination and the terminal,

(1a) the browser module including:

(1a-1) an information request function for designating URL with respect to the proxy module, and requesting a browsing object information acquisition;

(1a-2) an existing information acquiring and displaying function for acquiring and displaying a request result in the case where information relative to the request is already stored as a content cache in the proxy module;

(1a-3) an update event receiving function for receiving a content cache update event from the proxy module in the case where a content cache is updated in the proxy module;

(1a-4) an update content request function for requesting an acquisition of update content to the proxy module using a update URL included in the update event; and

(1a-5) an update content acquiring and displaying function for acquiring and displaying the result of the update content request,

(1b) the proxy module including:

(1b-1) an information request receiving function for receiving the browsing object information acquiring request from the browser module;

(1b-2) an existing information return function is a function for returning the browsing object information acquisition request to the browser module in the case where information relative to the received browsing object information acquisition request is already stored as a content cache;

(1b-6) an information request transfer function for transferring the request to an external server connected to a computer or a proxy server in the case where information relative to the received request is not stored as a content cache in the computer provided in the browser 4 with proxy server;

(1b-7) a cache update storage function for storing the browsing object information acquired from the external server or proxy server as the content cache based on the transfer result;

(1b-3) an update event transmitting function for transmitting the stored content cache update event to the browser module;

(1b-4) an update content request receiving function for receiving an update content request from the browser module receiving the transmission; and

(1b-5) an update content return function for transmitting a browsing object information acquired based on the transfer result to the browser module in accordance with the received request,

(1c) the proxy module having a cache update synchronizing function capable of synchronizing the content of the content cache stored in another proxy module with the content of the self content cache, by transmitting the content cache update event to another proxy module in the case where the content of the self content cache is updated, and by receiving another content cache update event from another proxy module in the case where the content of another content cache is updated, in order to always equalize the content of the content cache stored in the computer of each browser with proxy server between the proxy module and a proxy module of another browser with proxy server connected in an exchangeable state.

(2) Further, the present invention provides the browser with proxy server, wherein the external server or proxy server includes a Web server.

(3) Further, the present invention provides an information copying system, which can copy a browsing object information from one computer to another computer, comprising:

(3a) two computers including the browser with proxy server described in claim 1 or 2, and mutually exchangeable and connectable;

(3b) a network for connecting between the computers so that the computers can be mutually exchangeable; and

(3c) a network 6 for connecting with an external Web server providing the browsing object information requested by the function (1b-6) to the browser with proxy server, and for making exchangeable with the external Web server,

(3d) at least one browser with proxy server being the browser with proxy server described in claim 2,

(3e) the request result, that is, the same browsing object information being acquired and displayed in all browsers with proxy server constituting the information copying system when the browsing object information acquisition request by the function (1a-1) is made in the browser module of any one of the browsers with proxy server.

(4) Further, the present invention provides the information copying system, wherein the browsing object information acquisition request by the function (1a-1) is made in any one of the browsers with proxy server constituting the information copying system.

(5) Further, the present invention provides an information copying system, which can copy a browsing object information from one computer to another computer, comprising:

(5a) three or more computers including the browser with proxy server described in claim 1 or 2, and mutually exchangeable and connectable;

(5b) a network for connecting between the computers so that the computers can be mutually exchangeable; and

(5c) a network 6 for connecting with an external Web server providing the browsing object information requested by the function (1b-6) to the browser with proxy server, and for making exchangeable with the external Web server,

(5d) at least one browser with proxy server being the browser with proxy server described in claim 2,

(5e) the request result, that is, the same browsing object information being acquired and displayed in all browsers with proxy server constituting the information copying system when the browsing object information acquisition request by the function (1a-1) is made in the browser module of any one of the browsers with proxy server.

(6) Further, the present invention provides the information copying system, wherein at least one of the browsers with proxy server constituting the information copying system is set up in a mobile computer.

(7) Further, the present invention provides the information copying system, wherein

(7a) one computer operator makes an operation with respect to one browser with proxy server of browsers with proxy server provided in one computer, which is a computer operated by one computer operator, and thereby, a browser module makes a URL acquisition request relative to browsing object information with respect to a proxy module in one browser with proxy server,

(7b) in the case where a content cache relative to the information is stored in one computer, the proxy module transmits the URL to the proxy module of another browser with proxy server of browsers with proxy server provided in another computer, which is a computer operated by another computer operator,

(7b′) in the case where the content cache relative to the information is not stored in one computer, the browser module requests and receives a transmission of browsing object information including the URL to the Web server so that the information is stored as the content caches in one computer, and transmits the acquired URL to the proxy module of another computer,

(7c) in one computer, the proxy module constituting the browser with proxy server transmits information relative to the URL to the browser module, and displays the information on a screen of one computer,

(7d) in another computer receiving the URL, the proxy module constituting the browser with proxy server transmits the received URL to the browser module,

(7e) the browser module of another computer receiving the URL makes an acquisition request of the information relative to the URL to the proxy module,

(7f) the proxy module of another computer receiving the information acquisition request transmits the information to the browser module in the case where a content cache relative to the information is stored in another computer,

(7f′) in the case where the content cache relative to the information is not stored, the browser module requests and receives a transmission of the information to the proxy module of one computer so that the information is stored as the content cache in another computer, and the proxy module transmits the acquired information to the browser module of another computer,

(7g) the information is displayed on a screen of another computer.

(8) Further, the present invention provides a sales activity supporting method for supporting a sales activity using the information copying system described in any of claims 4 to 6, comprising the following steps of:

(8a) operating one computer by a sales activity supporter, who is capable of supporting a sales activity of a salesperson operates while operating another computer by a salesperson, who does sales activity;

(8b) connecting two computers by the salesperson or the sales activity supporter according to an exchange connection request between two computers from either the salesperson or the sales activity supporter; and

(8c) selecting browsing object information capable of supporting the sales activity done by the salesperson and operating a browsing object information acquisition request of the function (1a-1) by the sales activity supporter, and copying the information from the sales activity supporter computer to the salesperson computer so that the information can be displayed on a screen of the salesperson computer.

(9) Further, the present invention provides the sales activity supporting method, wherein the sales activity supporter is waiting in a state capable of operating the sales activity supporter computer in real time in accordance with a request from the salesperson, and the exchange connection request is made by electrical communication means exchangeable in real time.

### BRIEF DESCRIPTION OF THE DRAWINGS

FIG. 1 is a view to explain a configuration of browser with a proxy server according to the present invention;

FIG. 2 is a view to explain a configuration of information copying system according to the present invention;

FIG. 3 is a flowchart showing a flow of system procedure of the information copying system according to the present invention;

FIG. 4 is a view to explain a sales activity supporting method according to the present invention; and

FIG. 5 is a view to explain an operation concept of conventional technique, that is, pcAnywhere.

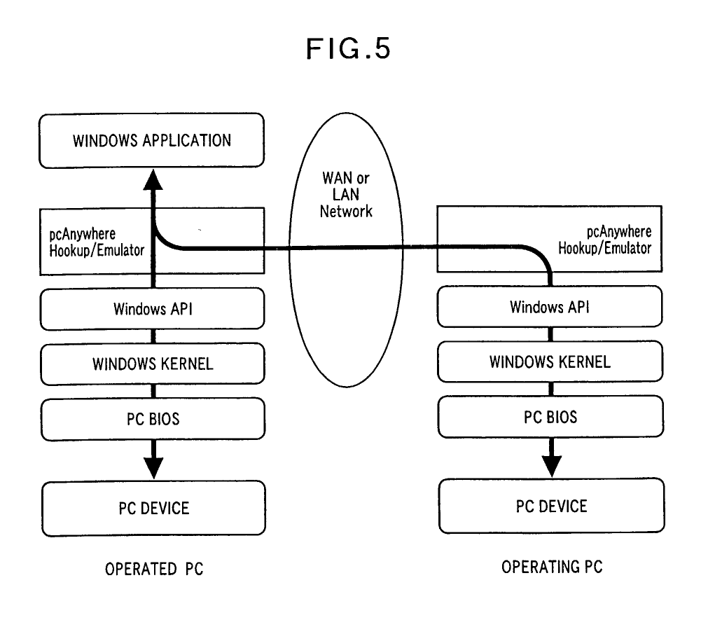

### DETAILED DESCRIPTION OF THE PREFERRED EMBODIMENTS

The present invention will be described in detail with reference to the accompanying drawings.

[Configuration]

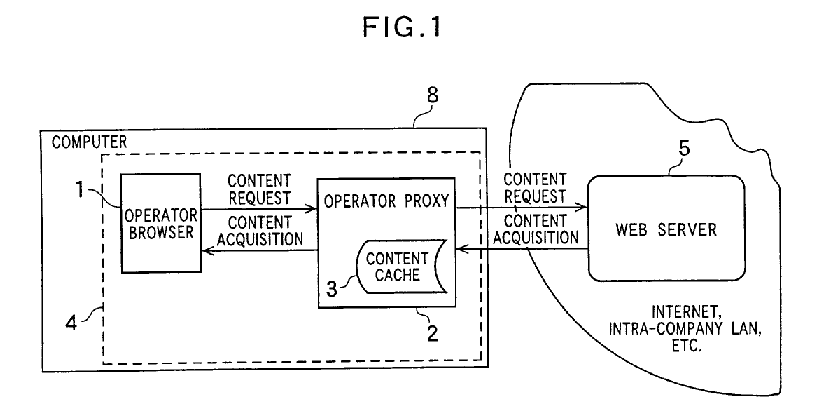

FIG. 1 is a view to explain a configuration of browser with a proxy server according to the present invention. In FIG. 1, a browser 4 with a proxy server of the present invention is mainly composed of a browser module 1 and a proxy module 2 connected to the browser module 1. The browser module has a browsing function for requesting, acquiring and displaying browsing object information, that is, for decoding a hypertext and displaying a designated Web content. On the other hand, the proxy module 2 has a function for receiving an information acquiring request of the browser module 1, transferring the information acquiring request to a Web server 5, acquiring information, storing the acquired information as a content cache 3, and returning existing information and update content to the browser module 1. That is, the proxy module 2 has a function for accepting an access request by http protocol from a terminal, acting a connection request from the terminal as a proxy, storing access designated page information as a cache, and relaying communication between the access designated destination and the terminal.

The browser module 1 includes an information request function (1a-1), an existing information acquiring and displaying function (1a-2), an update event receiving function (1a-3), an update content request function (1a-4) and an update content acquiring and displaying function (1a-5). More specifically, the information request function (1a-1) is a function for designating URL with respect to the proxy module 2, and requesting a browsing object information acquisition. The existing information acquiring and displaying function (1a-2) is a function for acquiring and displaying information in the case where information relative to browsing object information acquisition is already stored as a content cache 3 in a computer provided in the browser 4 with proxy server in the proxy module 2. The update event receiving function (1a-3) is a function for receiving an update event of the content cache 3 including update URL from the proxy module 2 in the case where the content cache 3 is updated in the proxy module 2. The update content request function (1a-4) is a function for designating update a URL included in the update event so as to request the acquisition of the content of the browsing object information relative to the update to the proxy module 2. The update content acquiring and displaying function (1a-5) is a function for acquiring and displaying the browsing object information as the result of the update content request.

The proxy module 2 includes an information request receiving function (1b-1), an existing information return function (1b-2), an information request transfer function (1b-6), a cache update storage function (1b-7), an update event transmitting function (1b-3), an update content request receiving function (1b-4) and an update content return function (1b-5). More specifically, the information request receiving function (1b-1) is a function for receiving the browsing object information acquisition request from the browser module 1. The existing information return function (1b-2) is a function for returning the browsing object information acquisition request to the browser module 1 in the case where information relative to the received browsing object information acquisition request is already stored as a content cache 3 in a computer provided in the browser 4 with proxy server. The information request transfer function (1b-6) is a function for transferring the information acquisition request to an external server connected to a computer or proxy server in the case where information relative to the received browsing object information acquisition request is not stored as a content cache 3 in the computer provided in the browser 4 with proxy server. The cache update storage function (1b-7) is a function for storing the browsing object information acquired from the external server or proxy server as the content cache 3 in the computer based on the transfer result. The update event transmitting function (1b-3) is a function for transmitting an update event including update URL relative to the stored content cache 3 to the browser module 1. The update content request receiving function (1b-4) is a function for receiving the browsing object information content acquisition request relative to the update from the browser module 1 receiving the transmission. The update content return function (1b-5) is a function for transmitting a browsing object information acquired based on the transfer result to the Web server 5 to the browser module 1 in accordance with the received request.

The Web server 5 connected to the computer provided in the browser 4 with proxy server, which can acquire the browsing object information from the Web system, may be used as the external server or proxy server of the function (1b-6).

Further, the proxy module 2 includes a cache update synchronizing function (1c). That is, in order to always equalize the content of the content cache stored in the computer of each browser with proxy server between the proxy module 2 and a proxy module of another browser with proxy server connected in an exchangeable state, the content of the content cache 3 in the computer provided with the self is updated. In this case, the proxy module 2 transmits the content cache update event another proxy module. Moreover, in the case where the content of the content cache 3 in the computer provided with another proxy module is updated, the proxy module 2 receives another content cache update event from another proxy module. By doing so, the proxy module 2 has the cache update synchronizing function (1c) capable of synchronizing the content of the content cache 3 in the computer provided with the self with the content of the content cache in the computer provided with another proxy module.

[Operation]

In FIG. 1, in the browser with proxy server according to the present invention, the operator designates and inputs URL in the browser module 1 in order to acquire the browsing object information. By doing so, the browser module 1 regards the URL input as an acquisition request of the browsing object information to the proxy module 2, and then, the acquisition request is received by the proxy module 2. In the case where the information relative to the received request is already stored as a content cache 3 in the computer provided in the browser 4 with proxy server, the existing information is returned to the browser module 1 by the proxy module 2. Thereafter, the returned existing information is received and acquired by the browser module 1, and then, is displayed on a display device of the computer provided in the browser 4 with proxy server.

The information relative to the browsing object information acquisition request received by the proxy module 2 is not stored as the content cache 3 in the computer provided with the browser 4 with proxy server. In this case, the proxy module 2 transfers the request to the external server or proxy server of the computer provided with the browser 4 with proxy server. Then, based on the transfer result, browsing object information newly acquired by the proxy module 2 from the external server or proxy server is stored as the content cache 3 updated in the computer. A content cache update event including update URL relative to the stored content cache 3 is transmitted to the browser module 1 by the proxy module 2, and then, the transmitted content cache update event is received by the browser module 1. Subsequently, the browser module 1 designates the update URL included in the update event with respect to the proxy module 2 in order to acquire the update content, and then, the update content acquisition request from the browser module 1 is received by the proxy module 2. In accordance with the received request, the proxy module 2 returns the browsing object information stored as the content cache 3 acquired based on the transfer result and updated in the computer to the browser module 1. The browsing object information returned as the result of the update content acquisition request is received and acquired by the browser module 1, and thereafter, is displayed on the display device of the computer provided with the browser with proxy server.

The proxy module 2 is connected in a state exchangeable with a proxy module of another browser with proxy server, and the content of the content cache 3 stored in the computer provided with the self browser is updated. In this case, the proxy module 2 transmits the content cache update event including update URL relative to the content cache update to another proxy module. Moreover, when the content of the content cache stored in the computer provided with another proxy module is updated, the proxy module 2 receives the content cache update event including update URL transmitted from another proxy module. By doing so, it is possible to synchronize the content of the content cache 3 in the computer provided with the proxy module 2 with the content of the content cache in the computer provided with another proxy module.

The Web server 5 connected to the computer provided with the browser 4 with proxy server may be used as the external server or proxy server. By doing so, the information relative to the acquisition request is acquired as the transfer result of the browsing object information acquisition request by the proxy module 2 from the Web system such as Internet via the Web server 5.

[Effect]

The browser with proxy server of the present invention has the configuration as described above. Therefore, the browser module 1 receives the content cache update event from the proxy module 2, and thereby, the browser module 1 can voluntarily acquire and update the content of browsing object information to be displayed in the self-browser.

Further, in the case where a plurality of the browsers with proxy server are connected, by the cache update synchronizing function, the browsing object information acquired and displayed by one browser with proxy server is automatically acquired and displayed in another browser with proxy server. Therefore, information copy from one computer to another computer can be carried out in a high-speed and stable operating state.

[Configuration]

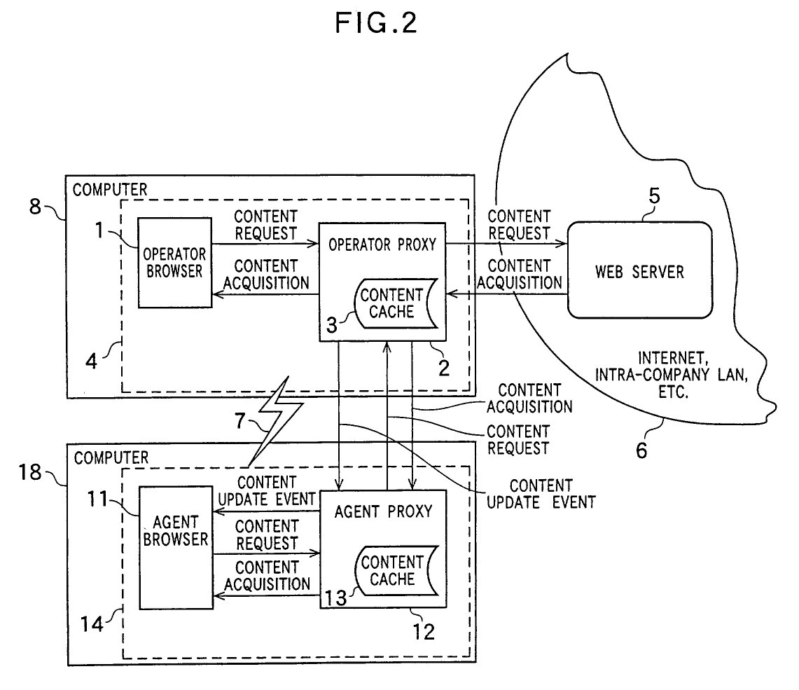

FIG. 2 is a view to explain a configuration of information copying system according to the present invention.

In FIG. 2, the information copying system is mainly composed of two computers 8 and 18 (3a), a network 7 (3b) and a network 6 (3c). That is, one computer 8 of two computers includes the browser 4 with proxy server having the browser module 1 and the proxy module 2, and is mutually exchangeable and connectable with another computer. On the other hand, another computer 18 of two computers includes a browser 14 with proxy server having a browser module 11 and a proxy module 12, and is mutually exchangeable and connectable with another computer. The network 7 connects between the computers 8 and 18 so that these computers can be mutually exchangeable. In the case where information relative to the received browsing object information acquisition request received by the proxy module 2 from the browser module 1 is not stored as the content cache 3 in the computer 8 in the browser with proxy server of the computer 8, the network 6 is connected and exchangeable with an external Web server 5. In this case, the external Web server 5 is an external server, which is connected to the proxy module 2 of the browser 4 with proxy server in order to provide the information acquired and requested in accordance with the transfer of request.

The computer is provided with at least one browser with proxy server of the browser 4 or 14 with proxy server, constituting the information copying system. Any of the computers may be a desktop type computer, and one of them may be a desktop type computer; the other thereof may be a mobile computer. Further, any of the computers may be a mobile computer. Therefore, for example, one computer may be a mobile computer such that the operator such as agent, who is doing sales activity in a movable state, is portable and operable.

In FIG. 2, the number of browsers with proxy server constituting the present system is two, and further, the number of browsers with proxy server connected with the Web server as the external server or proxy server is one. FIG. 2 shows one example of the system configuration, and the number of browsers with proxy server constituting the present system and the number of browsers with proxy server connected with the Web server are not limited to the above configuration. Therefore, the number of browsers with proxy server, that is, the number of computers provided with the browsers may be three or more.

The computer is provided with at least one browser with proxy server of the browser 4 or 14 with proxy server, constituting the information copying system. Any of the computers may be a desktop type computer, and one of them may be a desktop type computer; the other thereof may be a mobile computer. Further, any of the computers may be a mobile computer. Therefore, for example, one computer may be a mobile computer such that the operator such as agent, who is doing sales activity in a movable state, is portable and operable.

In the present invention, the network 7 is a typical Web system connected by Internet; however, the present invention is not limited to the above network, and for example, includes a network connected by a dedicated (leased) line.

Further, in the present invention, a local area network (hereinafter, referred to as “LAN”) built up in the company, Internet and the like are used as the network 6 connected with the Web server 5; however, the present invention is not limited to the above network. In this case, the LAN includes a server group for storing commodity/product information, customer information, sales promotion tool, marketing analysis information, trading history information and other knowledge. Further, Internet is capable of retrieving and acquiring various information used as sales activity support tool for timely obtaining a chance.

[Operation]

In the present system of FIG. 2, an update connection request is made from either of the computer 8, which is provided with the browser 4 with proxy server having the browser module 1 and the proxy module 2, or the computer 18, which is mutually exchangeable and connectable with the computer 8 and provided with the browser 14 with proxy server having the browser module 11 and the proxy module 12. When the above update connection request is made, the computers 8 and 18 are connected via the network 7 for making mutual exchangeable and connectable between the computers in the present system.

In the computer 8 provided with the browser with proxy server and connected directly with the Web server 5, when the operator has the input operation for URL designation, the browser module 1 of the browser 4 with proxy server in the computer 8 having the input operation makes the browsing object information acquisition request to the proxy module 2. Then, according to the operation by the browser with proxy server having the above-mentioned cache update synchronizing function and other various functions, the browsing object information acquisition request result, that is, the same browsing object information is acquired and displayed in the browser modules 1 and 11 of the all browsers with proxy server constituting the information copying system.

On the other hand, in the computer 18 provided with the browser with proxy server and connected directly with the Web server 5, when the operator has the input operation for URL designation, the browser module 11 of the browser 14 with proxy server in the computer 18 having the input operation makes the browsing object information acquisition request to the proxy module 12. Then, according to the operation by the browser with proxy server having the above-mentioned cache update synchronizing function and other various functions, the browsing object information acquisition request result, that is, the same browsing object information is acquired and displayed in the browser modules 1 and 11 of the all browsers with proxy server constituting the information copying system.

In the browser 4 with proxy server provided in the computer 8, the proxy module 2 receives information relative to the browsing object information acquisition request from the browser module 1. In the case where the information is not stored as the content cache 3 in the computer 8, the proxy module 2 transfers the browsing object information acquisition request to the Web server 5, which is the external server connected to the proxy module 2. Then, the Web server 5 receiving the transfer of the information acquires the browsing object information from the network 6 such as company LAN and Internet. Thereafter, according to the operation by the browser with proxy server having the above-mentioned cache update synchronizing function and other various functions, the browsing object information acquisition request result, that is, the same browsing object information is acquired and displayed in the browser modules 1 and 11 of the all browsers with proxy server constituting the information copying system.

On the other hand, in the browser 14 with proxy server provided in the computer 18, the proxy module 12 receives information relative to the browsing object information acquisition request from the browser module 11. In the case where the information is not stored as the content cache 3 in the computer 18, the proxy module 12 transfers the browsing object information acquisition request to the proxy module 2 of another browser 4 with proxy. Thereafter, according to the operation by the browser with proxy server, the browsing object information acquisition request result, that is, the same browsing object information is acquired and displayed in the browser modules 1 and 11 of the all browsers with proxy server constituting the information copying system.

In FIG. 2, there is shown a basic configuration example in the case where the number of the browsers with proxy server is two, and the number of the browsers with proxy server connected with the Web server as the external server or proxy server is one. Therefore, in the case where the number of the browsers with proxy server constituting the present system and the number of the browsers with proxy server connected with the Web server are different from FIG. 2, the information copying system of the present invention has the same operation as above.

In the information copying system of the present invention, the browsing object information acquisition request by the URL designation may be made in only any one browser with proxy server of the plurality of browsers with proxy server constituting the present system. According to the example of FIG. 2, in the computer 8, when the operator has the input operation for URL designation, the browser module 1 of the browser 4 with proxy server in the computer 8 having the input operation makes the browsing object information acquisition request to the proxy module 2. Then, according to the operation by the browser with proxy server having the above-mentioned cache update synchronizing function and other various functions, the browsing object information acquisition request result, that is, the same browsing object information is acquired and displayed in the browser modules 1 and 11 of the all browsers with proxy server constituting the information copying system.

[Effect]

The information copying system of the present invention has the configuration as described above; therefore, it is possible to copy the browsing object information such as Web page and video image displayed by the browser from one computer operated by one operator to another computer operated by the other operator in a high-speed and stable operating state. Thus, for example, it is possible to copy the information from a desktop type computer operated by the operator to a computer such as mobile PC operated by the operator such as agent in a state remote from the desktop computer.

Next, the information copying system of the present invention will be more detailedly described below according to the using method.

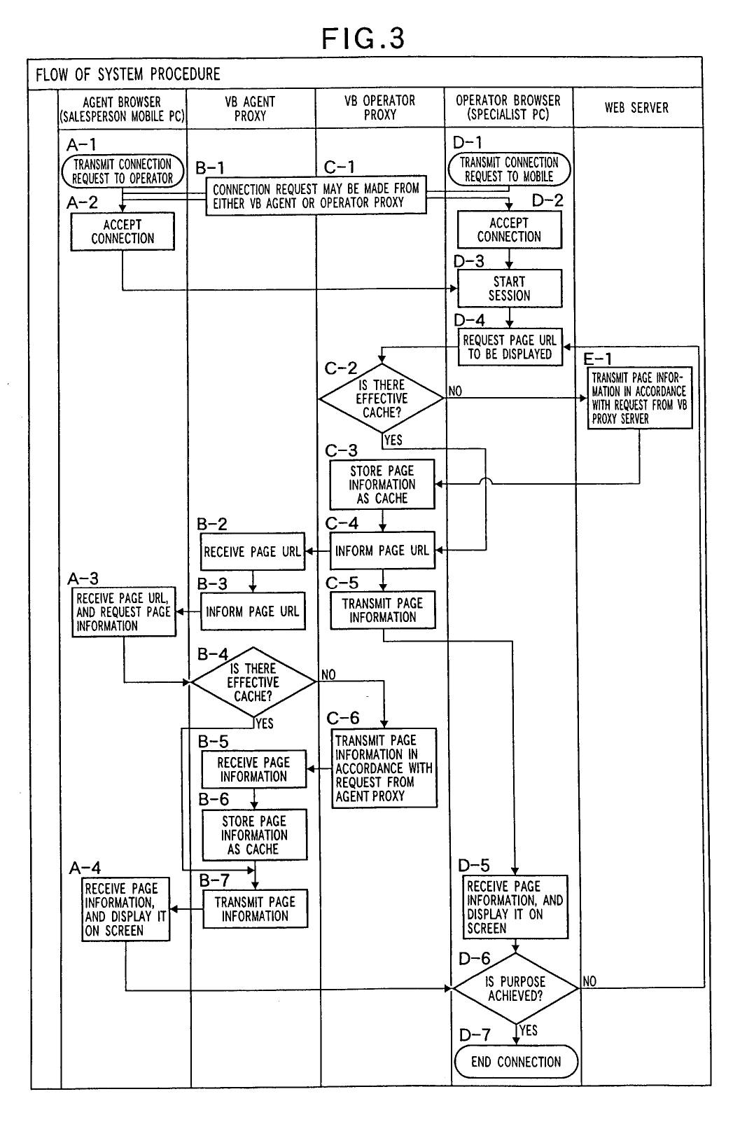

FIG. 3 is a flowchart showing a flow of system procedure of the information copying system according to the present invention. In FIG. 3, the information copying system is used by the following method, and the system procedure is carried out.

In FIG. 3 and the following description, “one computer operator”, the operated “one computer” and “one browser with proxy server” provided in the “one computer” shows the case where the operator operates the operator computer. Likewise, “another computer operator”, the operating “another computer” and “another browser with proxy server” provided in the “another computer” shows the case where the agent operates the agent computer. In this case, the information copying system according to the present invention is not limited to the above example.

Moreover, in FIG. 3 and the following description, the browser module (and computer) of the browser with proxy server of the operator computer is expressed as “operator browser (specialist PC)”, and the proxy module of the same is expressed as “VB operator proxy”. Further, the browser module (and computer) of the browser with proxy server of the agent computer is expressed as “agent browser (sales mobile PC)”, and the proxy module of the same is expressed as “VB agent proxy”. In this case, the identical reference numerals are used to designate the same elements as shown in FIG. 1 and FIG. 2. Incidentally, the above term “VB” is another name of the browser with proxy server of the present invention, and is an abbreviation of “Virtual Browser”.

(a) First, an agent has an agent computer 18 such as a mobile PC, and does outside sales activity. The agent makes an information providing request to an operator (specialist) operating the operator computer 8 using exchange connection request means such as phone, and then, starts up the agent browser 11 on the agent computer 18 so as to transmit a connection request to the operator browser 1 (A-1). The operator starts up the operator browser 1 on the operator computer 8 in the company so as to receive the connection from the agent browser 11 (D-2). In this case, the transmission and acceptance of the connection request may be made conversely between the agent and the operator (D-1, A-2).

When session is started between the agent computer 18 such as mobile PC of the agent and the operator computer 8 of the operator (D-3), by the operator's judgment and URL input operation to the operator computer 8 based on the judgment, the operator browser 1 requests URL relative to browsing object information to the VB operator proxy 2 (D-4). In this case, the browsing object information (hereinafter, referred to as “page information”) includes HTML including information judged as meeting to the agent request by the operator, video image and the like, and is displayed by a browser.

When receiving the page information, the VB operator proxy 2 confirms whether or not there exits effective cache 3 corresponding to the request page information in the operator computer 8 (C-2).

(b) In the case where the effective cache 3 corresponding to the request exists in the operator computer 8, the VB operator proxy 2 informs the VB agent proxy 12 in the agent computer 18 such as mobile PC operated by the agent of the page information URL (C-4).

(b′) In the case where no effective cache 3 corresponding to the request exists in the operator computer 8, the VB operator proxy 2 makes a page information request including the URL (hereinafter, referred to as “page URL”) to the Web server 5 (C-2).

In accordance with the page information request by the VB operator proxy 2, the page information is transmitted to the VB operator proxy 2 from the Web server 5 connected with the network 6 such as Internet or company LAN (E-1).

The page information received by the VB operator proxy 2 is stored as the cache 3 in the operator computer 8 by the VB operator proxy 2 while the acquired page URL being informed to the VB agent proxy 12 (C-4), and thereafter, the VB agent proxy 12 receives the URL page (B-2).

(c) Further, the page information received by the VB operator proxy 2 is transmitted to the operator browser 1 (C-5), and then, is displayed on the screen of the operator computer 8 (D-5).

(d) The page URL from the VB operator proxy 2 received by the VB agent proxy 12 (B-2) is informed to the agent browser 11 by the VB agent proxy 12 (B-3).

(e) When receiving the page URL from the VB agent proxy 12, the agent browser 11 makes a page information request corresponding to the page URL with respect to the VB agent proxy 12.

The VB agent proxy 12 receiving the page information request first confirms whether or not there exists an effective cache 13 corresponding to the requested page information in the agent computer 18 (B-4).

(f) In the case where the effective cache 13 corresponding to the requested page information exists in the operator computer 18, the VB agent proxy 12 transmits the page information stored as the cache 13 to the agent browser 11 (B-7).

(f′) In the case where no effective cache 13 corresponding to the requested page information exists in the operator computer 18, the page information acquisition request is transferred to the VB operator proxy 2 synchronizing with the VB agent proxy 12. Then, when receiving the request, the VB operator proxy 2 transmits the page information stored as the cache 3 in the operator computer 8 to the VB agent proxy 12 (C-6).

The page information transmitted from the VB operator proxy 2 is received by the VB agent proxy 12 (B-5), and then, is stored as the cache 13 in the agent computer 14(B-6), and thereafter, is transmitted to the agent browser 11 (B-7).

(g) The agent browser 11 receives the page information transmitted from the VB agent proxy 12 (B-7), and then, displays the page information on the screen of the agent computer 18 (A-4).

A decision is made whether or not the purpose for copying information is achieved by the content of page information displayed on the screen of the agent computer 18, and then, the result is transmitted from the agent to the operator using exchange connection request means such as telephone (D-6). In the case where the purpose is achieved, the connection ends between two computers 8 and 18 (D-7). In the case where the purpose is not achieved, or in the case where information copy is newly desired or required although the first purpose has been achieved, the connection is kept, or in the case where the connection ends once, a connection request is newly made, and thereafter, the above information copying process is repeated (D-4).

By using the information copying system of the present invention, the following effects can be obtained. More specifically, it is possible to copy the browsing object information such as Web page and video image displayed by browser from the computer operated by the operator (specialist) in company to the computer such as mobile PC operated by the agent in a state remote from the operator computer in a high-speed and stable operating state. Further, it is possible to support outside sales activity, that is, the agent skill in real time when the agent (salesperson) has the meeting with the client.

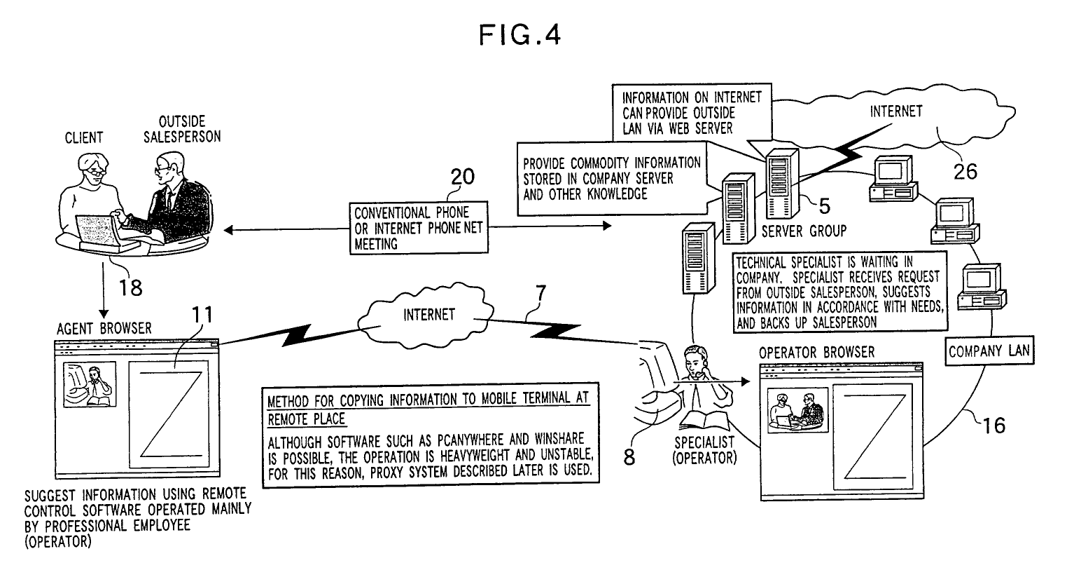

FIG. 4 is a view to explain a sales activity supporting method for supporting a sales activity using the information copying system of the present invention. In this case, like the case of FIG. 3, the identical reference numerals are used to designate the same elements as shown in FIG. 1 and FIG. 2.

In FIG. 4, the sales activity supporting method is carried out using the following information copying system, which is mainly composed of an operator computer 8, an agent computer 18, a network 7 and exchange connection request means 20. More specifically, the operator computer 8 is operated by a sales activity supporter (operator), who has technical knowledge and is capable of supporting a sales activity of salesperson described later. The agent computer 18 is operated by a salesperson (agent), who does sale activity in s movable state. The network 7 connects both computers 8 and 18 so that they are mutually exchangeable and connectable. The exchange connection request means 20 requests an exchange connection of the computers 8 and 18. First, the sales activity supporting method is carried out using the above information copying system. The sales activity supporting method mainly comprises the following steps. That is, one step is that two computers are connected by either of the agent or the operator according to an exchange connection request using exchange connection request means 20 between two computers from either of the agent or the operator. Further, one step is that page information capable of supporting sales activity and to be copied is judged, retrieved and selected by the operator, and a URL input operation based on the page information is made with respect to the operator computer 8. Further, one step is that the page information is copied from the operator computer 8 to the agent computer 18 so that the page information can be displayed on a screen of the agent computer 18, by the operation of the browser with proxy server and the information copying system.

According to the above sales activity supporting method, in accordance with the request from the agent, the operator is waiting in a state capable of operating the operator computer 8 in real time.

Further, in the sales activity supporting method, telecommunication means exchangeable in real time, that is, wireless or wire telephone, Internet phone, television phone, chat may be used as the exchange connection request means 20.

In the case where the page information copied to the agent computer 18 achieves the purpose for supporting the sales activity of the agent, the exchange connection for information copy ends by the operation of either of the operator or the agent. Then, the agent provides the page information displayed on the agent browser 11 of the agent computer 18 to the client, and continuously performs the sales activity thus supported.

In the case where the page information copied to the agent computer 18 achieves the purpose for supporting the sales activity of the agent, or in the case where information copy is newly desired or required although the first purpose has been achieved, the connection between two computers 8 and 18 is kept when the exchange is still connected. When the connection already ends, the agent again requests the information copy to the operator by the exchange connection request means 20, and thereafter, acquires new page information to the agent computer 18 by the above-mentioned method, and continuously performs the sales activity until the purpose for supporting the sales activity is achieved.

The page information displayed on the agent browser 11 of the agent computer 18 by the operation of the operator is simultaneously displayed on the operator browser 1 of the operator computer 8. Therefore, in the case where information copy is again required, it is possible to sufficiently have mutual understanding between the agent and the operator.

In the case of judging, retrieving and selecting the page information, the object is page information existing on network such as company LAN 16, Internet 26 via the Web server 5 connected and provided to the operator computer 8. Therefore, it is possible to copy commodity/product information on the company LAN 16, customer information, sales promotion tool, marketing analysis information, trading history information, other knowledge, and various information on the Internet 26 used as timely sales activity supporting tool to the agent computer 18.

As is evident from the above description, according to the present invention, in the browser with proxy server, the browser module receives the content cache update event from the proxy module. Therefore, the browser module can voluntarily acquire and update the content of browsing object information to be displayed in the self browser.

Further, in the case where a plurality of browsers with proxy server are connected, by the cache update synchronizing function, the browsing object information acquired and displayed by one browser with proxy server is automatically acquired and displayed in another browser with proxy server. Therefore, it is possible to copy information from one computer to another computer in a high-speed and stable operating state.

Moreover, according to the present invention, in the information copying system using the browser with proxy server, it is possible to copy the browsing object information such as Web page and video image displayed by the browser from one computer operated by the sales activity supporter (operator) to another computer operated by the salesperson (agent) in a state remote from the operator computer in a high-speed and stable operating state.

Moreover, according to the present invention, in the sales activity supporting method using the information copying system, information required for the agent doing outside sales activity is judged, retrieved and selected by the operator, and copied to the computer operated by the agent in a high-speed and stable operating state. Therefore, it is possible to support the agent skill in real time when the agent, who does outside seals activity, has the meeting with the client.

What is claimed is:

1. A browser with a proxy server comprising:
a browser module having a browsing function for decoding a hypertext and the like, and displaying a designated Web content; and
a proxy module having a function for accepting an access request by http protocol from a terminal, acting a connection request from the terminal as a proxy, storing access designated page information as a cache, and relaying communication between the access designated destination and the terminal,
(1a) the browser module including:
(1a-1) an information request function for designating URL with respect to the proxy module, and requesting a browsing object information acquisition;
(1a-2) an existing information acquiring and displaying function for acquiring and displaying a request result in the case where information relative to the request is already stored as a content cache in the proxy module;
(1a-3) an update event receiving function for receiving a content cache update event from the proxy module in the case where a content cache is updated in the proxy module;
(1a-4) an update content request function for requesting an acquisition of update content to the proxy module using a update URL included in the update event; and
(1a-5) an update content acquiring and displaying function for acquiring and displaying the result of the update content request,
(1b) the proxy module including:
(1b-1) an information request receiving function for receiving the browsing object information acquiring request from the browser module;
(1b-2) an existing information return function is a function for returning the browsing object information acquisition request to the browser module in the case where information relative to the received browsing object information acquisition request is already stored as a content cache;
(1b-6) an information request transfer function for transferring the request to an external server connected to a computer or a proxy server in the case where information relative to the received request is not stored as a content cache in the computer provided in the browser 4 with proxy server;
(1b-7) a cache update storage function for storing the browsing object information acquired from the external server or proxy server as the content cache based on the transfer result;
(1b-3) an update event transmitting function for transmitting the stored content cache update event to the browser module;
(1b-4) an update content request receiving function for receiving an update content request from the browser module receiving the transmission; and
(1b-5) an update content return function for transmitting a browsing object information acquired based on the transfer result to the browser module in accordance with the received request,
(1c) the proxy module having a cache update synchronizing function capable of synchronizing the content of the content cache stored in another proxy module with the content of the self content cache, by transmitting the content cache update event to another proxy module in the case where the content of the self content cache is updated, and by receiving another content cache update event from another proxy module in the case where the content of another content cache is updated, in order to always equalize the content of the content cache stored in the computer of each browser with proxy server between the proxy module and a proxy module of another browser with proxy server connected in an exchangeable state.

2. The browser with proxy server according to claim 1, wherein the external server or proxy server includes a Web server.

3. An information copying system, which can copy a browsing object information from one computer to another computer, comprising:
(3a) two computers including the browser with proxy server described in claim 1 or 2, and mutually exchangeable and connectable;
(3b) a network for connecting between the computers so that the computers can be mutually exchangeable; and
(3c) a network 6 for connecting with an external Web server providing the browsing object information requested by the function (1b-6) to the browser with proxy server, and for making exchangeable with the external Web server,
(3d) at least one browser with proxy server being the browser with proxy server described in claim 2,
(3e) the request result, that is, the same browsing object information being acquired and displayed in all browsers with proxy server constituting the information copying system when the browsing object information acquisition request by the function (1a-1) is made in the browser module of any one of the browsers with proxy server.

4. The information copying system according to claim 3, wherein the browsing object information acquisition request by the function (1a-1) is made in any one of the browsers with proxy server constituting the information copying system.

5. An information copying system, which can copy a browsing object information from one computer to another computer, comprising:
(5a) three or more computers including the browser with proxy server described in claim 1 or 2, and mutually exchangeable and connectable;
(5b) a network for connecting between the computers so that the computers can be mutually exchangeable; and
(5c) a network 6 for connecting with an external Web server providing the browsing object information requested by the function (1b-6) to the browser with proxy server, and for making exchangeable with the external Web server,
(5d) at least one browser with proxy server being the browser with proxy server described in claim 2,
(5e) the request result, that is, the same browsing object information being acquired and displayed in all browsers with proxy server constituting the information copying system when the browsing object information acquisition request by the function (1a-1) is made in the browser module of any one of the browsers with proxy server.

6. The information copying system according to any of claims 3 to 5, wherein at least one of the browsers with proxy server constituting the information copying system is set up in a mobile computer.

7. The information copying system according to any of claim 6, wherein
(7a) one computer operator makes an operation with respect to one browser with proxy server of browsers with proxy server provided in one computer, which is a computer operated by one computer operator, and thereby, a browser module makes a URL acquisition request relative to browsing object information with respect to a proxy module in one browser with proxy server,
(7b) in the case where a content cache relative to the information is stored in one computer, the proxy module transmits the URL to the proxy module of another browser with proxy server of browsers with proxy server provided in another computer, which is a computer operated by another computer operator,
(7b′) in the case where the content cache relative to the information is not stored in one computer, the browser module requests and receives a transmission of browsing object information including the URL to the Web server so that the information is stored as the content caches in one computer, and transmits the acquired URL to the proxy module of another computer,
(7c) in one computer, the proxy module constituting the browser with proxy server transmits information relative to the URL to the browser module, and displays the information on a screen of one computer,
(7d) in another computer receiving the URL, the proxy module constituting the browser with proxy server transmits the received URL to the browser module,
(7e) the browser module of another computer receiving the URL makes an acquisition request of the information relative to the URL to the proxy module,
(7f) the proxy module of another computer receiving the information acquisition request transmits the information to the browser module in the case where a content cache relative to the information is stored in another computer,
(7f′) in the case where the content cache relative to the information is not stored, the browser module requests and receives a transmission of the information to the proxy module of one computer so that the information is stored as the content cache in another computer, and the proxy module transmits the acquired information to the browser module of another computer,
(7g) the information is displayed on a screen of another computer.

8. A sales activity supporting method for supporting a sales activity using the information copying system described in any of claims 4 to 6, comprising the following steps of:
(8a) operating one computer by a sales activity supporter, who is capable of supporting a sales activity of a salesperson operates while operating another computer by a salesperson, who does sales activity;
(8b) connecting two computers by the salesperson or the sales activity supporter according to an exchange connection request between two computers from either the salesperson or the sales activity supporter; and
(8c) selecting browsing object information capable of supporting the sales activity done by the salesperson and operating a browsing object information acquisition request of the function (1a-1) by the sales activity supporter, and copying the information from the sales activity supporter computer to the salesperson computer so that the information can be displayed on a screen of the salesperson computer.

9. The sales activity supporting method according to claim 8, wherein the sales activity supporter is waiting in a state capable of operating the sales activity supporter computer in real time in accordance with a request from the salesperson, and the exchange connection request is made by electrical communication means exchangeable in real time.
